(19) United States
(12) Patent Application Publication
(10) Pub. No.: US 2007/0270310 A1
(43) Pub. Date: Nov. 22, 2007

(54) Methods of marking and related structures and compositions

(76) Inventors: David H. Blank, Lebanon, NH (US); Benjamin J. Brown, Keene, NH (US); Michael P. Secord, Chesterfield, NH (US); James W. Foley, Andover, MA (US)

Correspondence Address: FISH & RICHARDSON PC, P.O. BOX 1022, MINNEAPOLIS, MN, 55440-1022, US

(21) Appl. No.: 11/438,469

(22) Filed: May 22, 2006

(51) Int. Cl. C09D 11/00; B41M 5/24

(52) U.S. Cl. 503/226; 106/31.16; 106/31.2; 106/31.21; 106/31.22; 106/31.17; 427/532

(57) ABSTRACT

In one aspect, a method includes directing electromagnetic radiation to a structure, the structure including a substrate, a first layer, and a marking composition between the substrate and the first layer. At least a portion of the electromagnetic radiation is transmitted through the first layer, and the structure is marked.

### TECHNICAL FIELD

The invention relates to methods of marking, and related structures and compositions.

### BACKGROUND

Many food products are packaged and sold in flexible packaging to protect the products, to prolong the products' shelf life, and/or for the consumer's convenience. For example, products such as salty snacks (e.g., potato chips and pretzels) and baked goods are commonly packaged in flexible bags. Other food products such as confectionaries (e.g., candies and candy bars) are also commonly packaged in flexible bags or wrapped in flexible packaging. The packaging can include one layer (e.g., paper) or multiple layers where each layer may provide a different function (e.g., to prolong shelf life or to provide a desire aesthetic).

The packaging typically contains informative graphics and other marks. For example, the packaging may contain a decorative design or a distinctive feature, such as a company's trademark or logo. The packaging may also contain information such as a list of ingredients, a lot number from which the product was produced, and an expiration date. These graphics and marks can be made on the packaging using printing techniques, such as inkjet printing.

### SUMMARY

In one aspect, the invention relates to methods of marking, for example, to form a desired graphic or another mark on an article, such as flexible packaging. The methods can include directing electromagnetic radiation (e.g., from a laser) to an article having a marking composition. The marking composition is capable of interacting with the electromagnetic radiation to form the graphic or the mark. The invention also relates to marking compositions, and articles including the marking compositions and their uses.

In another aspect, the invention features a method, including directing electromagnetic radiation to a structure, the structure having a substrate, a first layer, and a marking composition between the substrate and the first layer, wherein at least a portion of the electromagnetic radiation is transmitted through the first layer, and the structure is marked.

Embodiments may include one or more of the following features. The electromagnetic radiation has a wavelength of from approximately 200 nanometers to approximately 15,000 nanometers. The electromagnetic radiation has a wavelength of from approximately 400 nanometers to approximately 1,200 nanometers. The electromagnetic radiation is delivered from a laser. The electromagnetic radiation has an energy density from approximately 0.4 J/cm² to approximately 1 J/cm². The substrate includes polyethylene, polypropylene, or poly(vinylidene chloride). The marking composition includes a dye and a color developer. The dye is unencapsulated. The dye includes a leuco dye. The color developer includes an acid. The marking composition includes from about 30 wt % to about 50 wt % of the dye and the color developer. The marking composition further includes an absorber capable of producing thermal energy upon interacting with the electromagnetic radiation. The marking composition includes from about 1 wt % to about 20 wt % of the absorber. The absorber includes a hydrous aluminosilicate. The marking composition further includes a solvent. The solvent includes water or an aqueous solution. The marking composition further includes a film-forming material. The film-forming material includes an acrylic resin or a urethane resin. The first layer includes a polymer. The first layer has a thickness of from approximately 0.1 mil to approximately 1.5 mil. The includes structure further includes an adhesive between the substrate and the first layer. The mark includes a number, a letter, a word, a symbol, or a bar code. The method includes enclosing a consumer product with the structure.

In another aspect, the invention features a method, including directing electromagnetic radiation to a marking composition on a substrate to form a mark, the marking composition comprising a dye and a color developer.

Embodiments may include one or more of the following features. The dye is unencapsulated. The dye includes a leuco dye. The color developer includes an acid. The marking composition includes from about 30 wt % to about 50 wt % of the dye and the color developer. The marking composition is substantially free of an absorber capable of producing thermal energy upon interacting with the electromagnetic radiation. The marking composition further includes an absorber capable of producing thermal energy upon interacting with the electromagnetic radiation. The marking composition includes from about 1 wt % to about 20 wt % of the absorber. The absorber includes a hydrous aluminosilicate. The electromagnetic radiation has a wavelength of from approximately 200 nanometers to approximately 15,000 nanometers. The electromagnetic radiation has a wavelength of from approximately 400 nanometers to approximately 1,200 nanometers. The electromagnetic radiation is delivered from a laser. The electromagnetic radiation has an energy density from approximately 0.4 J/cm² to approximately 1 J/cm². The substrate includes polyethylene, polypropylene, or poly(vinylidene chloride). The marking composition further includes a solvent. The solvent includes water or an aqueous solution. The marking composition further includes a film-forming material. The film-forming material includes an acrylic resin or a urethane resin. The mark includes a number, a letter, a word, a symbol, or a bar code. The method further includes enclosing a consumer product with the substrate and the marking composition. The electromagnetic radiation passes through a layer of material carried by the substrate before interacting with the marking composition.

In another aspect, the invention features a method, including directing electromagnetic radiation to a marking composition on a substrate to form a mark, the marking composition comprising a dye and an absorber capable of producing thermal energy upon interacting with the electromagnetic radiation.

Embodiments may include one or more of the following features. The dye is unencapsulated. The dye includes a leuco dye. The marking composition includes from about 1 wt % to about 20 wt % of the absorber. The absorber includes a hydrous aluminosilicate. The electromagnetic radiation has a wavelength of from approximately 200 nanometers to approximately 15,000 nanometers. The electromagnetic radiation has a wavelength of from approximately 400 nanometers to approximately 1,200 nanometers. The electromagnetic radiation is delivered from a laser. The electromagnetic radiation has an energy density from approximately 0.4 J/cm² to approximately 1 J/cm². The substrate includes polyethylene, polypropylene, or poly(vinylidene chloride). The marking composition further includes a color developer. The color developer includes an acid. The marking composition includes from about 30 wt % to about 50 wt % of the dye and the color developer. The marking composition further includes a solvent. The solvent includes water or an aqueous solution. The marking composition further includes a film-forming material. The film-forming material includes an acrylic resin or a urethane resin. The mark includes a number, a letter, a word, a symbol, or a bar code. The method further includes enclosing a consumer product with the substrate and the marking composition. The electromagnetic radiation passes through a layer of material carried by the substrate before interacting with the marking composition.

In another aspect, the invention features an article, including a substrate; a first layer; and a marking composition between the substrate and the first layer, the marking composition including a dye and a color developer, the marking composition being capable of interacting with incident electromagnetic radiation to form a mark.

Embodiments may include one or more of the following features. The dye is unencapsulated. The dye includes a leuco dye. The color developer includes comprises an acid. The marking composition includes from about 30 wt % to about 50 wt % of the dye and the color developer. The marking composition further includes an absorber capable of producing thermal energy upon interacting with the electromagnetic radiation. The marking composition includes from about 1 wt % to about 20 wt % of the absorber. The absorber includes a hydrous aluminosilicate. The marking composition further includes a solvent. The solvent includes water or an aqueous solution. The marking composition further includes a film-forming material. The film-forming material includes an acrylic resin or a urethane resin. The first layer includes a polymer. The first layer has a thickness of from approximately 0.1 mil to approximately 1.5 mil. The structure further includes an adhesive between the substrate and the first layer. The electromagnetic radiation has a wavelength of from approximately 200 nanometers to approximately 15,000 nanometers. The electromagnetic radiation is monochromatic laser energy. The electromagnetic radiation has an energy density from approximately 0.4 J/cm² to approximately 1 J/cm². The substrate includes polyethylene, polypropylene, or poly(vinylidene chloride).

In another aspect, the invention features an article, including a substrate; and a marking composition on the substrate, the marking composition including an absorber capable of producing thermal energy upon interacting with electromagnetic radiation, a dye, and a color developer, the marking composition being capable of interacting with the electromagnetic radiation to form a mark.

Embodiments may include one or more of the following features. The dye is unencapsulated. The dye includes a leuco dye. The color developer includes an acid. The marking composition includes from about 30 wt % to about 50 wt % of the dye and the color developer. The marking composition includes from about 1 wt % to about 20 wt % of the absorber. The absorber includes a hydrous aluminosilicate. The marking composition further includes a solvent. The solvent includes water or an aqueous solution. The marking composition further includes a film-forming material. The film-forming material includes an acrylic resin or a urethane resin. The electromagnetic radiation has a wavelength of from approximately 200 nanometers to approximately 15,000 nanometers. The electromagnetic radiation is monochromatic laser energy. The electromagnetic radiation has an energy density from approximately 0.4 J/cm² to approximately 1 J/cm². The substrate includes polyethylene, polypropylene, or poly(vinylidene chloride).

In another aspect, the invention features a marking composition, including an absorber capable of producing thermal energy upon interacting with electromagnetic radiation; and a thermally activatable coloring composition, wherein the marking composition is capable of interacting with the electromagnetic radiation to form a mark.

Embodiments may include one or more of the following features. The absorber has a maximum absorption wavelength from about 200 nm to about 15,000 nm. The absorber has a maximum absorption wavelength from about 8,000 nm to about 12,000 nm. The absorber includes a hydrous aluminosilicate. The absorber comprises a particle having an average dimension from about 0.1 micron to about 40 microns. The absorber is substantially transparent. The absorber is of a white color. The marking composition includes from about 1 wt % to about 20 wt % of the absorber. The thermally activatable coloring composition includes a dye and a color developer. The dye is unencapsulated. The dye includes a leuco dye. The color developer includes an acid. The marking composition further includes a solvent. The solvent includes water or an aqueous solution. The marking composition further includes a film-forming material. The film-forming material includes an acrylic resin or a urethane resin.

Embodiments of aspects of the invention can include one or more of the following advantages.

In some embodiments, the article to be marked includes multiple layers (e.g., multiple laminated layers) and a marking composition between at least two of the layers. The article can be marked by passing electromagnetic radiation (e.g., monochromatic laser energy) through at least one of the layers, and interacting the radiation with the marking composition to form a mark. As a result, the formed mark is not on an exposed surface, which can enhance the resistance of the mark to changes or other possible adulterations (e.g., due to chemical contact, abrasion, or other physical contact).

Also, because marking with electromagnetic radiation does not require physically contacting the marking composition, contamination to the mark is reduced.

Electromagnetic radiation having low energies can be used to form a mark, and as a result, the mark can be formed without negatively affecting one or more layers. For example, low laser energy can pass through one or more layers of material without substantially damaging (e.g., perforating, producing bubbles in, or otherwise compromising) the layer(s). The low laser energy can interact with the marking composition to form a mark without substantially damaging one or more layers (e.g., a substrate) underlying the marking composition.

In some embodiments, a mark is generated in a short amount of time. For example, a mark can be generated in less than about 250 microseconds (e.g., less than about 50 microseconds) without damaging a layer of material, such as a bi-axially oriented polypropylene film of 1.0 mil thickness. Damage can be determined by visually inspecting the marked material under a microscope. For example, an Olympus SZX12 microscope having bottom lighting, a DPFL APO 1.2× PF objective lens, and a Dolan-Jenner MI-150 illuminator for top lighting can be used. In some embodiments, visualization can be enhanced by using polarized light with an SPX-PO filter under the marked material and a rotatable SZX-AN filter attached to the objective lens. Damaged material can appear, for example, as one or more perforations and/or bubbling.

Marking with electromagnetic radiation (e.g., from a laser) can be reliable and cost effective. For example, because no physical contact of components is needed to form a mark, maintenance and/or repair (e.g., of moving components) can be reduced, thereby reducing the down time of the marking system. Marking with electromagnetic radiation can also provide a digital solution to marking (e.g., printing), and/or a marking approach that can be conveniently retrofitted into existing manufacturing systems.

The marking composition is also versatile. For example, the marking composition can be applied to a number of structures, such as on an exterior surface of a structure, or between layers of a multilayer (e.g., laminated) structure. In some embodiments, the energy required to create a mark is not significantly changed when the marking composition is between layers of a multilayer structure. In some embodiments, the marking composition does not thermally degrade (e.g., show premature color development) when subjected to layering techniques used in the packaging industry (e.g., in a lamination process where temperatures greater than about 550° F. can be reached). The marking composition can be marked without negatively affecting (e.g., perforating) the structure carrying the composition, such as certain standard packaging films (e.g., bi-axially oriented polypropylene films of 1.0 mil thickness).

The marking composition may include a color agent (e.g., a dye) that is a part of the laminating chemistry.

A marking composition can be included in a composition to provide a material that is hundred percent solids (e.g., without solvent). For example, the marking composition can be incorporated in a matrix that is UV curable, for example, by mixing it with epoxy or acrylate monomers. In some embodiments, one or more dyes and one or more absorbers are mixed with one or more UV curable monomers in the absence of solvent. The mixture can be substantially of a color developer. On exposure to UV radiation, the mixture cures, and the marking composition is formed on an article which can be marked by the methods described herein.

Other aspects, features and advantages will be apparent from the description of the following embodiments and from the claims.

### BRIEF DESCRIPTION OF DRAWINGS

FIG. 1A is a perspective view of an embodiment of a flexible package; and FIG. 1B is a detailed, cross-sectional view of the package of FIG. 1A.

FIG. 2A is schematic diagram of an embodiment of a method of marking; and FIG. 2B is a detailed view of FIG. 2A.

FIG. 3 is a detailed, cross-sectional view of an embodiment of a multilayer structure.

FIG. 4 is an image of a lased mark.

### DETAILED DESCRIPTION

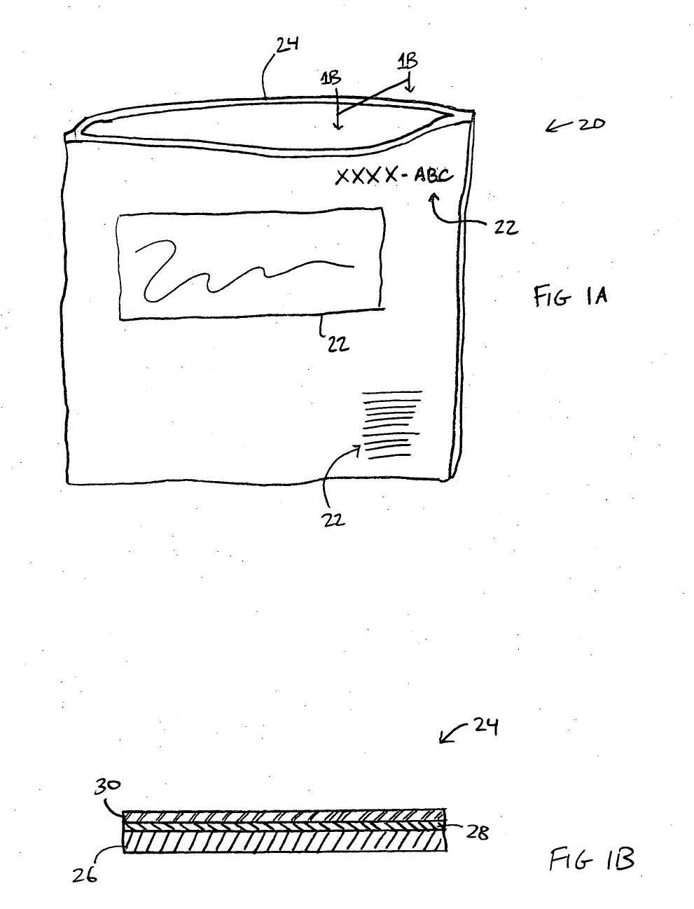

FIG. 1A shows a package 20 that can be used to store and to sell consumer goods, such as baked goods (e.g., pretzels, cookies and chips) and confectioneries. As shown, package 20 bears a variety of marks 22, such as a desired graphic, a list of ingredients, a “used by” date, an expiration date, a bar code, and a lot number. Referring now to FIG. 1B, package 20 is formed of a multilayer structure 24 that (as shown) includes a substrate 26 (a first layer), an exterior protective layer 30 (a second layer) coextensive with the substrate, and a marking composition 28 between the substrate and the protective layer. Substrate 26 (e.g., a metallized polymer layer) can be used to extend the shelf life or freshness of the consumer goods. Marking composition 28 can be used to provide a desired graphic and/or to allow a desired mark to be formed in structure 24, as described below. Protective layer 30 (e.g., a bi-axially oriented polypropylene layer) can be used to protect a formed graphic(s) and/or mark(s) from unwanted changes. In some embodiments, marking composition 28 is applied to protective layer 30, and the protective layer is subsequently laminated to substrate 26 with an extrudate (e.g., ethylene-methyl-acrylate (EVA) modified polyethylene) to form multilayer structure 24.

Marking composition 28 can be used to provide a desired graphic, and/or to form a desired mark by applying the marking composition to protective layer 30, and optionally, applying energy, such as electromagnetic radiation, (e.g., lasing) the marking composition to form the desired mark. In particular, the desired graphic (such as a manufacturer's logo) can be formed by applying marking composition 28 to protective layer 30 using techniques such as flexographic printing and gravure printing. Additionally or alternatively, marking composition 28 can be applied to one or more areas of protective layer 30 that are subsequently addressed with electromagnetic radiation to form the desired mark (such as an expiration date). As discussed herein, marking with electromagnetic radiation can enhance the reliability and cost-efficiency of manufacturing, among other benefits.

Marking composition 28 is generally capable of interacting with electromagnetic radiation (such as from a laser) and/or the heat generated by the radiation to irreversibly form a mark that can be detected visually. In some embodiments, marking composition 28 includes a thermally activatable coloring composition and an absorber capable of producing thermal energy upon irradiation with electromagnetic radiation. The thermally activatable coloring composition can include, for example, a dye and a color developer. Marking composition 28 can further include a solvent and/or a film-forming agent.

As used herein, an “absorber” refers to a material that can produce thermal energy upon irradiation of electromagnetic radiation (e.g., from a laser). Without wishing to bound by theory, it is believed that the absorber can interact with (e.g., absorb) incident energy (e.g., energy having a wavelength of from approximately 400 nm to approximately 1,200 nm) and generate thermal energy from the incident energy. The thermal energy produced from the absorber can activate the thermally activatable coloring composition in marking composition 28 to form a mark. The absorber is generally stable under common environmental conditions (e.g., at room temperature and under atmospheric pressure). In some embodiments, the absorber is compatible with other materials in marking composition 28 (e.g., by not generating a color change upon mixing with other materials in the marking composition).

In some embodiments, the absorber contains particles having an average dimension (e.g., an average diameter) of at least approximately 0.1 micron (e.g., at least approximately 1 micron) and/or at most approximately 40 microns (e.g., at most approximately 20 microns, at most approximately 15 microns).

The absorber can have a maximum absorption in a broad range of wavelengths, depending, for example, on the particular marking composition and incident energy used. In some embodiments, an absorber has a maximum absorption wavelength from approximately 400 nm to approximately 1,200 nm (e.g., from approximately 460 nm to approximately 840 nm). Examples of absorbers include KF1151 PINA, KF1152 PINA, KF1026 PINA, SDA7950, SDA1816, Photo dye KF 1126 PINA, Photo dye KF 1127 PINA, SDA 4927, SDD 5712, KF839TS, A-183, SDA1037, PJ 800NP, and PJ 830NP. All KF PINA materials are available from Honeywell, Seelze GmbH (Seelze, Germany). All SDD and SDA are available from H. W. Sands (Jupiter, Fla.). PJ800NP and PJ830NP are available from Avecia (Manchester, UK). In some embodiments, an absorber has a maximum absorption wavelength from approximately 8,000 nm to approximately 12,000 nm. Examples of absorbers include hydrous aluminosilicates, Mearlin Magnapearl 3100 (41.0-53.0% titanium dioxide, 0.35-0.83% tin dioxide, 46.0-59.0% mica), Engelhard Alsibronz 6 Mica (100% mica (CAS #12001-26-2)), Neogen 2000 (China clay (CAS #86402-68-4)), ASP G90 Kaolin Clay (hydrous kaolin (CAS #1332-58-7)), and ASP 170 Kaolin Clay (100% hydrous kaolin powder or aluminum silicate (CAS #1332-58-7)). Mearlin Magnapearl 3100, Engelhard Alsibronz 6 mica, and ASP 170 and G90 are available from Engelhard Corp. (Iselin, N.J. or North Charleston, S.C.), and Neogen 2000 is available from Imerys (Paris, France).

In some embodiments, the absorber is substantially transparent within the 400-700 nm region. As used herein, a “transparent absorber” refers to a material that, when used in a marking composition, transmits at least about 80% (e.g., at least about 85%, at least about 90%) of light within the 400-700 nm region. In certain embodiments, the absorber has a white color or another suitable color.

A marking composition can include two or more different absorbers. In some embodiments, each absorber has a maximum absorption wavelength different from those of other absorbers. For example, an absorber having a maximum absorption at approximately 780 nm can be combined with another absorber having a maximum absorption at approximately 820 nm to provide a marking composition that has a broadened region of strong absorption within the entire range of 780-820 nm. Such compositions can be particularly useful if wavelength shifts occur with photonic energy sources due to increases in operating temperature.

In some embodiments, the absorber(s) is at least approximately 1 wt % (e.g., at least approximately 4 wt % or at least approximately 8 wt %), and/or at most approximately 20 wt % (at most approximately 16 wt % or at most approximately 12 wt %) of a marking composition. For example, a marking composition can include approximately 10 wt % of the absorber(s). In other embodiments, e.g., for absorbers that absorb at approximately 808 nm, the absorber is at most approximately 1 wt %, or at least approximately 0.05 wt % of a marking composition.

As used herein, a “thermally activatable coloring composition” refers to a composition that can generate a color change (e.g., an irreversible color change) upon exposure to a selected stimulus, such as a sufficient amount of thermal energy. In some embodiments, the color change can be from a first color (e.g., white) or no color to a second contrasting color (e.g., black or purple). A thermally activatable coloring composition is generally stable under common environmental conditions (e.g., at room temperature and under atmospheric pressure). Preferably, a thermally activatable coloring agent is compatible with other materials in a marking composition (e.g., without generating color change upon mixing with other materials in the marking composition).

As indicated above, in some embodiments, the thermally activatable coloring composition includes a dye, such as a leuco dye. The chemistry and formulation of leuco dye compositions are known in the art, such as those described in U.S. Pat. Nos. 3,539,375; 3,674,535; 4,151,748; 4,181,771; 4,246,318; and 4,470,057, the contents of which are incorporated herein by reference. Examples of leuco dyes include those available from Ciba Specialty Chemicals (Basel, Switzerland) under the Pergascript line, such as Pergascript Yellow I3R, Pergascript Green I-2GN, Pergascript Orange I-G, Pergascript Red I-6B, Pergascript Blue S-RB, Pergascript Blue I-2R, Pergascript Black I-R, and Pergascript Black I-2R.

In some embodiments, the thermally activatable coloring composition also includes a color developer that is capable of reacting with the dye to produce a color change. Examples of color developers include acids or materials capable of generating an acid moiety, for example, upon reaching a particular threshold (e.g., by heating to a particular temperature). For example, Ciba® PERGAFAST™ 201, a room temperature solid available from Ciba Specialty Chemicals, can provide an acidic moiety for color development of leuco dyes when activated with heat. Other room temperature solid materials, such as some hindered phenols (e.g., 4,4′-isopropylidenebis(2,6-dibromophenol) (Aldrich) where the acidic hydrogen on the hydroxyl group is hindered from physically contacting the leuco dye), can also serve as a source of an acid moiety. The solid materials can undergo a melt phase to allow the acidic moiety to have intimate contact with the leuco dye. As a result, phenols or other hindered acidic color developers can be chosen based on their melting points. Other examples of color developers include pre-acids, which can be described as molecules that can undergo a structural change to present an acidic moiety. In some embodiments, the structural change that occurs is the elimination of one or more groups that leads to a rearrangement and presents an acidic moiety. Examples of pre-acids are available from Midori Kagaku Co., Ltd., (Toshima-Ku, Tokyo) and include, for example, 4-Nitrobenzyl tosylate (tradename NB-201), Bis(4-tert-butylphenyl)iodonium triflate (tradename BBI-105), 5-Norborn-2,3-dicarboximidyl tosylate (tradename NDI-101), Alpha-[[[(4-Methylphenyl)sulfonyl]oxy]imino] benzeneacetonitrile (tradename PAI-01), 4-Methoxyphenylpenyliodonium triflate (tradename MPI-105), 4-Methoxy-alpha[[[(4-methylphenyl)sulfonyl]oxy]imino]benzeneacetonitrle (tradename PAI-101), 2-(3,4-Dimethoxyphenyl)-4,6-bis-(trichloromethyl)-1,3,5-triazine (tradename TAZ-108), 2,4,6-Tris(trichloromethyl)-s-triazine (tradename TAZ-101), which develop into a green/black or black color between a temperature of approximately 95-180° C. Still other examples of pre-acids include ionic pairs (e.g., salts) of acids, commonly referred to as blocked acids. For example, amine salts of para-toluene sulfonic acid, such as Nacure 2170 (King Industries Inc., Norwalk, Conn.), which is described as a para-toluene sulfonic acid with an activation temperature of 90° C. may be used. The amine group, which acts as a blocking group and is used in creating the salt, can be responsible for the temperature where the acid is regenerated through decomposition of the ionic pair, thereby providing a trigger for color development. By knowing when the acidic moiety is formed (e.g., the melting point of the solid material, when a structural change occurs, or the activation temperature of blocked acid) and selecting the desired color developer, a desired color development can be achieved. Also, by selecting the appropriate color developer, certain events, such as premature color development from interactions between the acid and the leuco dye caused by a lamination process, can be prevented.

In some embodiments, the materials of the thermally activatable coloring composition (e.g., the dye and the color developer) are dispersed as solid particles, but not dissolved, in a solvent. Without wishing to the bound by theory, it is believed that the dye and the color developer in such a marking composition are separated into two phases, thereby reducing (e.g., preventing) any reaction between them, e.g., before the application of heat. In some embodiments, at least approximately 90 wt % (e.g., at least approximately 95 wt % or at least approximately 99 wt %) of the dye does not react with the color developer before the application of heat. After being heated to a selected (e.g., activation) temperature, it is believed that the dye and the color developer melt into one phase and react with each other to generate a color change. In other embodiments, such as where a pre-acid is present, the dye and/or the color developer may be dissolved into a solvent, and a color change is not realized until a threshold (e.g., a threshold temperature) is reached. This threshold may be, for example, a physical or a structural change, such as a loss of an amino blocking group (e.g., in an ionically paired blocked acid compound) or a structural rearrangement where the acidic moiety is generated. Other examples of activatable coloring compositions that can be utilized in some embodiments are the Kromagen line of products, such as K90, K120, and K170 and KS170, from Thermographic Measurements Co. Ltd. (Flintshire, UK), which are examples of non-encapsulated leuco-color developer color activatable systems.

A marking composition can include two or more different thermally activatable coloring compositions. For example, one or more thermally activatable coloring compositions can generate a color change different from one or more other different thermally activatable coloring compositions. In some embodiments, each thermally activatable coloring composition has a threshold (e.g., an activation temperature or structural change) different from those of other different thermally activatable coloring compositions.

A marking composition generally contains a sufficient amount of one or more thermally activatable coloring compositions to produce a visible color change during marking. In some embodiments, the thermally activatable coloring composition(s) is at least approximately 10 wt % (e.g., at least approximately 20 wt % or at least approximately 40 wt %), and/or at most approximately 50 wt % (e.g., at most approximately 45 wt % or at most approximately 40 wt %) of a marking composition. In other embodiments, the thermally activatable coloring composition(s) constitutes up to 100 wt % of a marking composition.

As indicated above, in some embodiments, a marking composition includes a solvent that is compatible with the other material(s) in the marking composition. For example, the solvent does not generate a premature color change, e.g., by dissolving the color developer. The solvent can include water or an aqueous solution, such as one that contains an amine or other pH modifier or surfactant. Exemplary amines used with aqueous solutions include monoethanolamine. Surfactants for water-borne coatings are well known in the art and may include surface tension modifiers, flow and leveling agents, and the like. Organic solvents can also be used and can include any solvent that is suitable for the application of the marking composition, and/or capable of dissolving other materials in the marking composition. Exemplary organic solvents include ethyl alcohol, propyl alcohol, isopropyl alcohol, acetone, ethyl acetate, propyl acetate, and similar solvents. In some embodiments, organic solvents with pre-acids in which no background color development is realized are used. The amount of the solvent can range, for example, from approximately zero wt % (e.g., for dry marking compositions) to approximately 80 wt %, and can be adjusted based on the desired viscosity of the marking composition. For example, the viscosity can be adjusted to meet one or more requirements of the marking process in which the marking composition is to be used. Viscosities can range, for example, from approximately 200 to approximately 1500 cPs for flexographic printing; from approximately 1500 to approximately 3000 cPs for reciprocal pad printing; and from approximately 35,000 to approximately 55,000 cPs for screen printing.

In some embodiments, a marking composition contains one or more film-forming agents that facilitate film formation from the marking composition. Examples of film-forming agents include acrylic resins or urethane resins. Commercially available acrylic resins include JONCRYL 2621 and JONREZ 2064, from Johnson Polymer (Sturtevant, Wis.); Lucidene 351, Lucidene 243, Lucidene 604, Lucidene 605, and Lucidene 605NV, from Rohm & Haas (Philadelphia, Pa.); Rhoplex 3208 and Rhoplex CL-105 from Rohm and Haas (Philadelphia, Pa.); Neocryl BT44, NeoCryl 1127, NeoCryl 1120, NeoCryl 1052, and NeoCryl 5090 from DSM Neoresins (Wilmington, Mass.); Carboset GA1604, Carboset GA1993, and Carboset GA2236 from Noveon Inc. (Cleveland, Ohio); Zinpol 280 from Noveon Inc. (Cleveland, Ohio); and Glascol LE15 from Ciba Specialty Chemicals (Tarrytown, N.Y.). Commercially available urethane resins include UROTUF L56 MPW36 from Reichold (Durham, N.C.); and NeoRez 563, NeoRez 551, NeoRez R-972, NeoRez R-9621, NeoRez R-966, and NeoRez R-940 from DSM Neoresins (Wilmington, Mass.). INX Flexo Lamial II inks (water and solvent based flexographic printing inks) are available from INX International Ink Co.). The film forming agent can be an acrylic resin. The amount of the film forming agent(s) can be determined by, for example, the amount of solids in the marking composition and/or the ability to laminate packaging 20 adequately after printing.

A marking composition can also contain other additives, such as a leveling agent or surface wetting agent (e.g., BYK®-307, BYK®-310 and BYK®-331) or a rheology modifier (e.g., DISPERBYK®-110) both from Byk-Chemie (Wesel, Germany). Still other additives, such as a defoamer, a material that can wet out a surface of a substrate, and/or those common in the printing industry, can be used in a marking composition.

A marking composition can be prepared by the following methods. A predetermined amount of a thermally activatable coloring composition and water can first be added into a vessel to form a mixture. While the mixture is being stirred, a predetermined amount of an absorber can then be added slowly. The resultant mixture can be stirred at a high speed to obtain a dispersion containing particles of a certain size (e.g., <10 microns). A film-forming agent and other additives can then be added, and the mixture thus obtained can be stirred at a low speed until a homogenous mixture is obtained. In some embodiments, such as for water-based marking compositions, the mixture can be adjusted to a certain pH (e.g., >7.5 by addition of an amine, such as monoethanol amine) to control the drying speed of the marking compositions.

Still referring to FIG. 1B, protective layer 30 can include any material capable of allowing at least a portion of incident electromagnetic radiation to be transmitted to interact with marking composition 28 and to form a mark. In some embodiments, at least approximately 20% (e.g., at least approximately 30%, at least approximately 40%, at least approximately 50%, at least approximately 60%, at least approximately 70%, at least approximately 80%) of the incident electromagnetic radiation (e.g., laser energy) is transmitted through protective layer 30. Protective layer 30 can include one or more polymers, such as polyethylene, polyester and polypropylene. More than one protective layer, such as multiple laminated protective layers, can be used. The total thickness of protective layer(s) 30 can range from approximately 0.1 mil (thousandth of an inch) to approximately 1.5 mil.

Substrate 26 (another layer of structure 24) can include any material capable of supporting or being supported by marking composition 28 and/or protective layer 30. Examples of substrate 26 include a flexible film or a rigid film (e.g., a polymer film), label stock and coated fabric label tape. A specific example of substrate 26 is metallized polypropylene used in the food packaging industry. In other embodiments, substrate 26 include glass, metals, fiber or paper board, paper stock, corrugated, chip board, rigid plastics and semi-rigid plastics. More than one substrate, such as multiple layers of laminated substrates, can be used. The total thickness of substrate(s) can range from approximately 0.1 mil to approximately 4 mils.

Examples of materials for package 20 and applications include, but are not limited to, blister packs, skin packs, vacuum packages, caps, lids, tubs, closures, form/fill/seal packages (both those filled horizontally and vertically), checkweighers, wrappers (such as clear overwraps), bottles, and cans. Other applications on which marking can be accomplished include fabric label tape, labels and the products themselves (e.g., by applying a marking composition on the product).

Multilayer structure 24 can be made according the following methods. Marking composition 28 can be applied onto protective layer 30 in selected portion(s) via a suitable method, such as flexographic printing, gravure printing, spray printing, pad printing, flood coating, and screen printing. In some embodiments, marking composition 28 forms a layer having a thickness ranging from approximately 1.0 micron to approximately 25 microns on protective layer 30. Marking composition 28 can be dried (e.g., air dried). Next, protective layer 30 with marking composition 28 applied thereon can be applied (e.g., laminated) to substrate 26. For example, an adhesive (such as an extrudate including ethylene methyl acrylate-modified polyethylene at approximately ≧550° F.) can be applied between protective layer 30 and substrate 26, and the protective layer and the substrate can be passed between two rollers (e.g., calendered between a pressure roller and a chilled roller) to form multilayer structure 24. Even at these high temperatures (e.g., approximately ≧550° F.), marking composition 28 does not prematurely develop a color (e.g., due to the dye and the color developer contacting via a melt or generation of an acid). In some embodiments, marking composition 28 is applied to substrate 26, alternatively or additionally to applying the marking composition to protective layer 30. Examples of multilayer structures include those containing oriented polypolypropylene (OPP), metallized OPP, cavitated OPP, metallized cavitated OPP, poly(vinylidene chloride) (PVDC), PVDC/OPP, polyethylene (PE), and/or metallized PE. These materials can be used, for example, as materials for the substrate and/or the protective layer.

To form a mark, electromagnetic radiation is applied to marking composition 28. For example, laser energy can be passed through protective layer 30 to address marking composition 28 for a certain amount of time. Without wishing to be bound by theory, it is believed that the incident electromagnetic radiation can be absorbed by the absorber in marking composition 28 to produce thermal energy, which in turn can generate a color change from the thermally activatable coloring composition. Examples of sources that can deliver electromagnetic radiation having a wavelength from about 400 nm to 1,200 nm include lasers of the type Cr:Forsterite (1150-1350 nm), HeNe (1152, 612, 594, and 543 nm), argon (1090, 501.7, 496.5, 488, 476.5, and 457.9 nm), Nd:YAG (1080 nm), Nd:YAG (1064 nm), Nd:glass (1060 nm), YbYAG, ErYAG, NdYVO₄, NdGdVO₄, Nd:YLF (1053 or 1047 nm), Ti:sapphire (700-1000 nm), GaAs/GaAlAs (780-905 nm), GaP, InGaP, GaN, InGaAs (980 nm), krypton (799.3, 752.5, 676.4, 647.1, 568.2 or 530.9 nm), Cr:LiSAF (780-1060 nm), InP, ruby (694 nm), InGaAlP (635-660 nm), Cu (578 and 511 nm), HeCd (442 nm), N2+ (428 nm) and GaInP. In some embodiments, the electromagnetic radiation generated by a laser can have an energy density from approximately 0.40 J/cm² to approximately 1 J/cm². Marking composition 28 can be addressed for at least approximately 50 microseconds to approximately 1 second to generate an optically detectable mark, e.g., a pixel of approximately 250 micrometers. Examples of marks that can be generated include a number, a letter, a word, a bar code, a graphic (such as a trademark or a logo), and a graph.

The marks can be used to label a variety of end products. For example, referring to FIGS. 2A and 2B, in food packaging, multilayer structure 24 can be addressed by a laser 40 to form mark 22 (as shown, a bar code) as the multilayer structure is delivered flatly from a supply roll 42 to a take-up roll 44. Subsequently, the marked multilayer structure can be joined with another structure (e.g., heat sealed on three sides to another multilayer structure 24) to form packages 20. Packages 20 can then be cut into individual units, filled with the selected food product, and completely sealed. In other embodiments, one or more marks 22 can be formed after packages 20 are filled with their contents.

While a number of embodiments have been described, still other embodiments are possible.

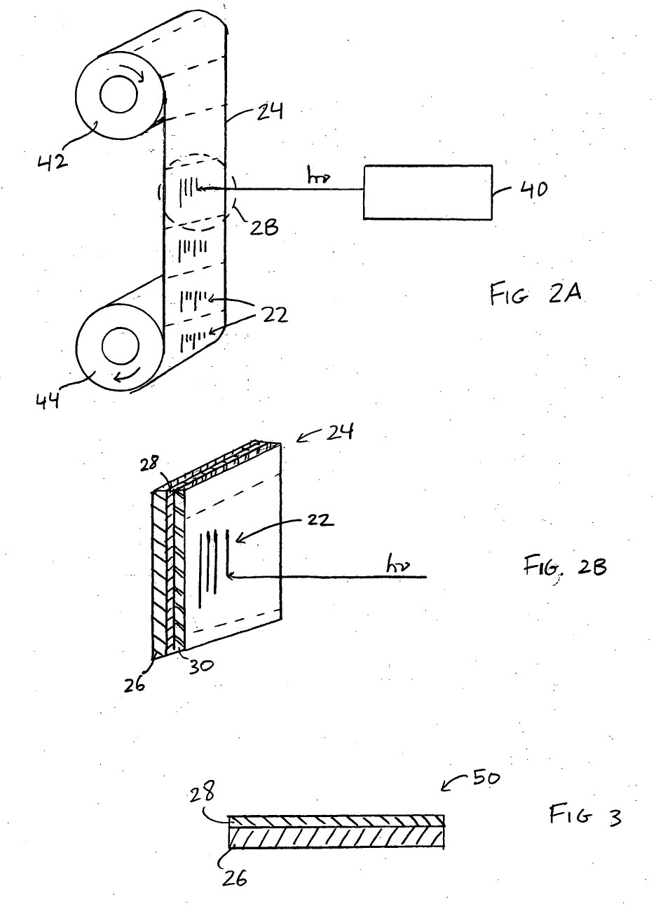

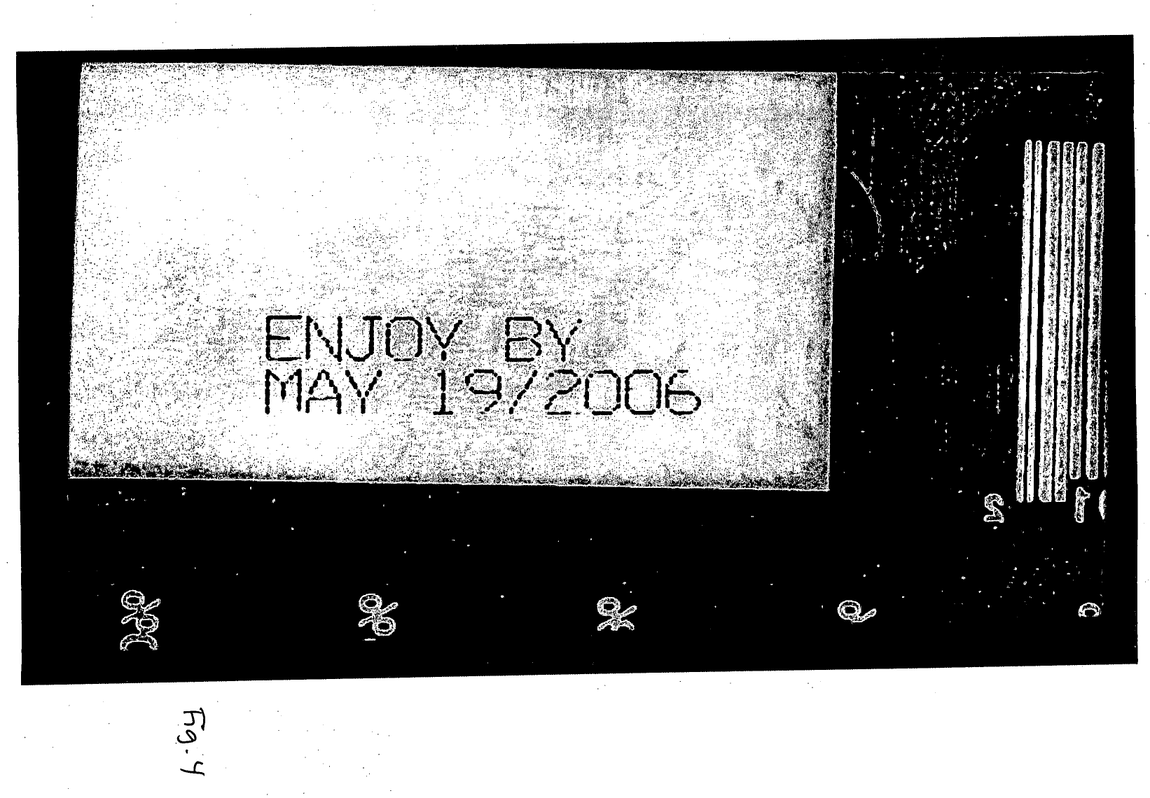

As an example, while electromagnetic radiation is described above as passing through one or more layers to form a mark, in other embodiments, the electromagnetic radiation does not pass through a layer of material before addressing a marking composition. Referring to FIG. 3, a multilayer structure 50 includes substrate 26 and marking composition 28 disposed on the substrate as an exterior or exposed layer. To form a mark, electromagnetic radiation (hv) is addressed directly to marking composition 28 without passing through a layer of material.

As another example, in some embodiments, a marking composition is substantially free (e.g., less than or equal to approximately 1 wt %) of an absorber. Because thermal energy can activate the color former (e.g., dye) and color developer combination, marking can be accomplished when energy sufficient to cause activation is absorbed by the combination. For example, by varying the amount of the energy source (e.g., laser or heater) power, duration of application, and/or the concentration and/or thickness of the activatable combination, varying degrees of color activation and marking can be accomplished without an absorber.

In some embodiments, a structure including a marking composition can be heated (e.g., by contact with a heated surface, or heated in a tunnel) to lower the activation threshold of the thermally activatable coloring composition. As a result, less energy can be used to form a mark.

In some embodiments, a marking composition is substantially free (e.g., less than or equal to approximately 5 wt %, approximately 3 wt %, approximately 1 wt %) of a color developer. A marking composition can include a mixture having one or more absorbers and one or more dyes. For example, absorbing clays, in the absence of a separate color developer, can facilitate the development of color when energy (e.g., heat) is absorbed by the combination of clay and dye composition. As an example, a marking composition can be combined (e.g., compounded) with one or more polymers (e.g., a thermoplastic resin), and this combination can addressed with energy (e.g., laser energy) to form a mark. The marking composition can include from approximately 1 wt % to approximately 99 wt % of absorber(s), and from approximately 1 wt % to approximately 99 wt % of dye(s). The combination of the marking composition and the polymer(s) can include from approximately 0.1 wt % to approximately 50 wt % of the marking composition, and from approximately 50 wt % to approximately 99 wt % of the polymer(s). The combination of the marking composition and the polymer(s) can include more than one marking composition. The combination of the marking composition(s) and the polymer(s) can be used in applications such as bread bag closures and other applications of marking on rigid and semi-rigid substrates.

In some embodiments, a multilayer structure includes any two or more different marking compositions described herein. For example, a multilayer structure can include a first marking composition with a first activation temperature, a second marking composition with a second activation temperature different from the first activation temperature, and one or more layers of material between the first and second marking compositions. To form a first color (e.g., blue), one of the marking compositions can be selectively activated with an appropriate temperature by applying the appropriate energy, while not activating the other marking composition. To form a second color (e.g., purple or blackish), the other marking composition can be selectively activated with the appropriate energy. The second color can be a combination of the first color and the color developed by the other marking composition. In some embodiments, the first and second marking compositions have different absorbers selected to interact with predetermined wavelengths so that colors can be selectively developed, depending on the incident energy being used. A resultant color or the mark observed can be a combination of separately generated colors. Activatable layers can become transparent, opaque, or a specific color depending on the composition chosen and application.

A mark can be formed without applying electromagnetic radiation, e.g., from a laser. For example, any method of delivering heat to or creating heat on a marking composition can be used to generate a color change. Examples of methods include but are not limited to thermal printing, hot stamp, and hot air jet.

A multilayer structure can include more than three layers, for example, four layers, five layers, six layers, seven layers, or more than eight layers. As an example, a multilayer structure that can be used for packaging food can include an inner layer of paper (for stiffness). A layer of a marking composition can be applied on the exterior surface of the paper, and a polyethylene layer can be applied on the exterior surface of the marking composition. The inner surface of the paper can laminated to a layer of polyethylene, a layer of aluminum foil (for aseptic packages), and two layers of food grade polyethylene. As a result, the only material to the touch the contents of the package is foodgrade polyethylene.

The following examples are illustrative and not intended to be limiting.

### EXAMPLE 1

18.3 pounds of Kromagen Black K170 (TMC Inc.) and 3.4 pounds of deionized water were added into a ten-gallon vessel and mixed slowly at approximately 800 rpm using a Cowles mixer. While stirring, 3.66 pounds of ASP170 (absorber) was added slowly to the vessel to avoid formation of clumps. The mixture thus obtained was then sheared at 1500 rpm for 60 minutes until a dispersion containing particles no larger than 10 microns, as measured by a Hegman gauge (also known as a paint test equipment fineness of grind gauge), was obtained. (A Hegman gauge is a precision gauge manufactured from hardened stainless steel and has two ground channels giving scales of both Hegman (one Hegman equals 12.7 microns) and microns. The Hegman gauge is used by placing the mixture into the top end of the gauge and drawing the mixture down using a scraper blade. The measurement in microns can be made where the particles have been screened out. The associated standards are ISO 1524, BS3900, C6, DIN 53-203, ASTM D1210, ASTM D1316, and ASTM D333.) The wall of the vessel was scraped periodically to remove any solid material stuck to it.

Following the high speed dispersion step, the mixer was turned back to a low speed of approximately 800 rpm, and 14.64 pounds of INXLAM OPAQUE WHITE (INX International Ink Co., Elk Grove Village, Ill.) was added to the vessel. The mixture was stirred for approximately 30 minutes at this speed until homogeneous. The pH of the resulting mixture was then adjusted to 7.5 by adding approximately 4 ounces of a 25% monoethanol amine and water solution to the vessel. The resulting coating had a viscosity of 1420 cP as measured with a Brookfield RVT viscometer using spindle 4 at 20 rpm.

A portion of the coating was then printed onto oriented polypropylene, Bicor SLP™ film from ExxonMobil using a central impression flexographic printing press. The printed film with the coating was laminated to metallized OPP, MET-HB from ExxonMobile, using OPTEMA TC120 extrudate from ExxonMobile.

After printing and lamination, the laminated film was imaged (marked) using a MARKEM Smartlase 110 laser at one spot per pixel and a power setting of 25%, with a dwell time of 250 microseconds, resulting in the image shown in FIG. 4. The image showed marked permanence by showing no optical loss over a period at three months.

### EXAMPLE 2

Adding an absorber allows for the generation of a mark at lower power and reduced dwell time or combinations thereof. The absorber can prevent perforation of the substrate film, on which the marking composition is formed, by laser energy. In some embodiments, a mark can be generated using a marking composition that is substantially free of a distinct absorber. By varying the amounts of the energy source (e.g., laser or heater) power, duration of application (dwell time), and/or the concentration and/or thickness of the marking composition, varying degrees of color activation and marking can be accomplished without an absorber.

The description that follows is made with reference to the tables below. Draw downs were made of each sample onto 1.25 mil BOPP films. For Sample #1, a solvent based system, a #95 hand proffer was used with one ink layer deposited resulting with a film coat weight of 6.28 g/m². For KS-170 samples, a #95 hand proffer was also used with five ink layers deposited resulting with a coat weight of 5.78 g/m². For Sample 2, a water based system, a #2 wire wound rod (WWR) on the automatic draw down machine with one ink layer having a dry coat weight of 5.11 g/m². For K-170, a #95 hand proffer was used with one ink layer with a dry coat weight of 5.14 g/m².

Samples were then applied onto 2.5″×2.5″ pieces of white card stock and a mark was formed by imaging with a Smartlase 110 10W CO₂ laser (available from MARKEM Corporation) using power and dwell settings that are listed on each of the samples below. An Olympus DP10 microscope with a magnification set at 108 was used. For each power setting, a microphotograph was taken, and a micro ruler (with increments of ten micron per line) was also photographed. Spot size was measured and recorded comparing Sample 1 with the KS-170 and Sample 2 with K-170. Samples were compared with and without the absorber present.

As shown in Table 2, in both water and solvent based systems, successful marking was accomplished without an added absorber by varying the power and dwell time of the energy source.

TABLE 1

| | | | Sample 1a | | |
|---|---|---|---|---|---|
| Sample 1 | | | without absorber | | |
| Material | % Weight | grams | Material | % Weight | grams |
| Kromagen | 55 | 27.5 | Kromagen | 65 | 27.5 |
| Black KS170 | | | Black KS170 | | |
| White Flexo | 30.00 | 15.00 | White Flexo | 35 | 15.00 |
| Lamial II | | | Lamial II | | |
| ASP-170 | 15.00 | 7.50 | | | |
| (absorber) | | | | | |
| Total | 100.00 | 50.00 | Total | 100.00 | 42.5 |

| | |
|---|---|
| | Sample 2a |
| Sample 2 | without absorber |

| Material | % Weight | Material | % Weight |
|---|---|---|---|
| Kromagen | 90 | Kromagen | 100 |
| Black K170 | | Black K170 | |
| ASP-170 | 10 | | |
| (absorber) | | | |
| Total | 100.00 | Total | |

TABLE 2

| | | Sample 1a - KS-170 | | Sample 2a - K-170 |
|---|---|---|---|---|
| | Sample 1 | formulation-no | Sample 2 | formulation |
| Power/Dwell Time | (with absorber) | absorber | (with absorber) | no absorber |
| % peak power/ms) | spot size - microns | spot size in microns | spot size in microns | spot size in microns |
| 20/200 | 130 | 60 | 200 | 100 |
| 25/250 | 220 | | 200 | 150 |
| 35/250 | 250 | 190 | 240 | 150 |
| 45/250 | 320 | 240 | 340 | 180 |
| 50/250 | 360 | 240 | 290 | 220 |

### EXAMPLE 3

In this example, a marking composition was mixed and incorporated with a polymer (e.g., high impact polystyrene resin), and a mark was formed by addressing on the resulting rigid or semi-rigid material with energy (e.g., laser imaging).

Five grams of 17.8% high impact polystyrene dissolved zylene (90.9%) was mixed with 0.2 gram benzoyl methylene blue dye (3.63%) 0.3 gram ASP-170 absorber (5.45%) to form a sample mixture. A small amount of the sample was spread out on the bottom of an aluminum weighing pan and allowed to air dry. The sample was semi-rigid and relatively stiff. The sample was marked to form an image using the Smartlase 110 CO₂ laser at 100% power and a dwell time of 500 ms with a spot size of 3 spots per pixel.

Other embodiments are within the claims.

What is claimed is:

1. A method, comprising:
directing electromagnetic radiation to a structure, the structure comprising a substrate, a first layer, and a marking composition between the substrate and the first layer,
wherein at least a portion of the electromagnetic radiation is transmitted through the first layer, and the structure is marked.

2. The method of claim 1, wherein the electromagnetic radiation has a wavelength of from approximately 200 nanometers to approximately 15,000 nanometers.

3. The method of claim 1, wherein the electromagnetic radiation has a wavelength of from approximately 400 nanometers to approximately 1,200 nanometers.

4. The method of claim 1, wherein the electromagnetic radiation is delivered from a laser.

5. The method of claim 1, wherein the electromagnetic radiation has an energy density from approximately 0.4 J/cm² to approximately 1 J/cm².

6. The method of claim 1, wherein the substrate comprises a material selected from the group consisting of polyethylene, polypropylene, and poly(vinylidene chloride).

7. The method of claim 1, wherein the marking composition comprises a dye and a color developer.

8. The method of claim 7, wherein the dye is unencapsulated.

9. The method of claim 8, wherein the dye comprises a leuco dye.

10. The method of claim 7, wherein the color developer comprises an acid.

11. The method of claim 7, wherein the marking composition comprises from about 30 wt % to about 50 wt % of the dye and the color developer.

12. The method of claim 7, wherein the marking composition further comprises an absorber capable of producing thermal energy upon interacting with the electromagnetic radiation.

13. The method of claim 12, wherein the marking composition comprises from about 1 wt % to about 20 wt % of the absorber.

14. The method of claim 12, wherein the absorber comprises a hydrous aluminosilicate.

15. The method of claim 7, wherein the marking composition further comprises a solvent.

16. The method of claim 15, wherein the solvent comprises water or an aqueous solution.

17. The method of claim 7, wherein the marking composition further comprises a film-forming material.

18. The method of claim 17, wherein the film-forming material comprises an acrylic resin or a urethane resin.

19. The method of claim 1, wherein the first layer comprises a polymer.

20. The method of claim 1, wherein the first layer has a thickness of from approximately 0.1 mil to approximately 1.5 mil.

21. The method of claim 1, wherein the structure further comprises an adhesive between the substrate and the first layer.

22. The method of claim 1, wherein the mark comprises a number, a letter, a word, a symbol, or a bar code.

23. The method of claim 1, further comprising enclosing a consumer product with the structure.

24. A method, comprising:
directing electromagnetic radiation to a marking composition on a substrate to form a mark, the marking composition comprising a dye and a color developer.

25. The method of claim 24, wherein the dye is unencapsulated.

26. The method of claim 25, wherein the dye comprises a leuco dye.

27. The method of claim 24, wherein the color developer comprises an acid.

28. The method of claim 24, wherein the marking composition comprises from about 30 wt % to about 50 wt % of the dye and the color developer.

29. The method of claim 24, wherein the marking composition is substantially free of an absorber capable of producing thermal energy upon interacting with the electromagnetic radiation.

30. The method of claim 24, wherein the marking composition further comprises an absorber capable of producing thermal energy upon interacting with the electromagnetic radiation.

31. The method of claim 29, wherein the marking composition comprises from about 1 wt % to about 20 wt % of the absorber.

32. The method of claim 30, wherein the absorber comprises a hydrous aluminosilicate.

33. The method of claim 24, wherein the electromagnetic radiation has a wavelength of from approximately 200 nanometers to approximately 15,000 nanometers.

34. The method of claim 24, wherein the electromagnetic radiation has a wavelength of from approximately 400 nanometers to approximately 1,200 nanometers.

35. The method of claim 24, wherein the electromagnetic radiation is delivered from a laser.

36. The method of claim 24, wherein the electromagnetic radiation has an energy density from approximately 0.4 J/cm² to approximately 1 J/cm².

37. The method of claim 24, wherein the substrate comprises a material selected from the group consisting of polyethylene, polypropylene, and poly(vinylidene chloride).

38. The method of claim 24, wherein the marking composition further comprises a solvent.

39. The method of claim 37, wherein the solvent comprises water or an aqueous solution.

40. The method of claim 24, wherein the marking composition further comprises a film-forming material.

41. The method of claim 39, wherein the film-forming material comprises an acrylic resin or a urethane resin.

42. The method of claim 24, wherein the mark comprises a number, a letter, a word, a symbol, or a bar code.

43. The method of claim 24, further comprising enclosing a consumer product with the substrate and the marking composition.

44. The method of claim 24, wherein the electromagnetic radiation passes through a layer of material carried by the substrate before interacting with the marking composition.

45. An article, comprising:
a substrate;
a first layer; and
a marking composition between the substrate and the first layer, the marking composition comprising a dye and a color developer, the marking composition being capable of interacting with incident electromagnetic radiation to form a mark.

46. The article of claim 45, wherein the dye is unencapsulated.

47. The article of claim 46 wherein the dye comprises a leuco dye.

48. The article of claim 45, wherein the color developer comprises an acid.

49. The article of claim 45, wherein the marking composition comprises from about 30 wt % to about 50 wt % of the dye and the color developer.

50. The article of claim 45, wherein the marking composition further comprises an absorber capable of producing thermal energy upon interacting with the electromagnetic radiation.

51. The article of claim 50, wherein the marking composition comprises from about 1 wt % to about 20 wt % of the absorber.

52. The article of claim 50, wherein the absorber comprises a hydrous aluminosilicate.

53. The article of claim 45, wherein the marking composition further comprises a solvent.

54. The article of claim 45, wherein the solvent comprises water or an aqueous solution.

55. The article of claim 45, wherein the marking composition further comprises a film-forming material.

56. The article of claim 55, wherein the film-forming material comprises an acrylic resin or a urethane resin.

57. The article of claim 45, wherein the first layer comprises a polymer.

58. The article of claim 45, wherein the first layer has a thickness of from approximately 0.1 mil to approximately 1.5 mil.

59. The article of claim 45, wherein the structure further comprises an adhesive between the substrate and the first layer.

60. The article of claim 45, wherein the electromagnetic radiation has a wavelength of from approximately 200 nanometers to approximately 15,000 nanometers.

61. The article of claim 45, wherein the electromagnetic radiation is monochromatic laser energy.

62. The article of claim 45, wherein the electromagnetic radiation has an energy density from approximately 0.4 J/cm² to approximately 1 J/cm².

63. The article of claim 45, wherein the substrate comprises a material selected from the group consisting of polyethylene, polypropylene, and poly(vinylidene chloride).

64. An article, comprising:
a substrate; and
a marking composition on the substrate, the marking composition comprising an absorber capable of producing thermal energy upon interacting with electromagnetic radiation, a dye, and a color developer, the marking composition being capable of interacting with the electromagnetic radiation to form a mark.

65. The article of claim 64, wherein the dye is unencapsulated.

66. The article of claim 64, wherein the dye comprises a leuco dye.

67. The article of claim 64, wherein the color developer comprises an acid.

68. The article of claim 64, wherein the marking composition comprises from about 30 wt % to about 50 wt % of the dye and the color developer.

69. The article of claim 64, wherein the marking composition comprises from about 1 wt % to about 20 wt % of the absorber.

70. The article of claim 64, wherein the absorber comprises a hydrous aluminosilicate.

71. The article of claim 64, wherein the marking composition further comprises a solvent.

72. The article of claim 64, wherein the solvent comprises water or an aqueous solution.

73. The article of claim 64, wherein the marking composition further comprises a film-forming material.

74. The article of claim 73, wherein the film-forming material comprises an acrylic resin or a urethane resin.

75. The article of claim 64, wherein the electromagnetic radiation has a wavelength of from approximately 200 nanometers to approximately 15,000 nanometers.

76. The article of claim 64, wherein the electromagnetic radiation is monochromatic laser energy.

77. The article of claim 64, wherein the electromagnetic radiation has an energy density from approximately 0.4 J/cm² to approximately 1 J/cm².

78. The article of claim 64, wherein the substrate comprises a material selected from the group consisting of polyethylene, polypropylene, and poly(vinylidene chloride).

79. A marking composition, comprising:
an absorber capable of producing thermal energy upon interacting with electromagnetic radiation; and
a thermally activatable coloring composition,
wherein the marking composition is capable of interacting with the electromagnetic radiation to form a mark.

80. The marking composition of claim 79, wherein the absorber has a maximum absorption wavelength from about 200 nm to about 15,000 nm.

81. The marking composition of claim 79, wherein the absorber has a maximum absorption wavelength from about 8,000 nm to about 12,000 nm.

82. The marking composition of claim 79, wherein the absorber comprises a hydrous aluminosilicate.

83. The marking composition of claim 77, wherein the absorber comprises a particle having an average dimension from about 0.1 micron to about 40 microns.

84. The marking composition of claim 79, wherein the absorber is substantially transparent.

85. The marking composition of claim 79, wherein the absorber is of a white color.

86. The marking composition of claim 79, wherein the marking composition comprises from about 1 wt % to about 20 wt % of the absorber.

87. The marking composition of claim 79, wherein the thermally activatable coloring composition comprises a dye and a color developer.

88. The marking composition of claim 87, wherein the dye is unencapsulated.

89. The marking composition of claim 87, wherein the dye comprises a leuco dye.

90. The marking composition of claim 87, wherein the color developer comprises an acid.

91. The marking composition of claim 87, wherein the marking composition further comprises a solvent.

92. The marking composition of claim 91, wherein the solvent comprises water or an aqueous solution.

93. The marking composition of claim 87, wherein the marking composition further comprises a film-forming material.

94. The marking composition of claim 93, wherein the film-forming material comprises an acrylic resin or a urethane resin.
